(19) United States
(12) Patent Application Publication
(10) Pub. No.: US 2008/0100820 A1
(43) Pub. Date: May 1, 2008

(54) RANGE SENSOR USING STRUCTURED LIGHT INTENSITY

(75) Inventor: David William Sesko, Woodinville, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: MITUTOYO CORPORATION, Kawasaki-shi (JP)

(21) Appl. No.: 11/537,547

(22) Filed: Sep. 29, 2006

(51) Int. Cl. G01C 3/08; G01B 11/14

(52) U.S. Cl. 356/4.01; 356/4.07; 356/614

(57) ABSTRACT

A range sensor using structured light intensity for determining displacement measurements. A micro-lens array or diffractive optical element inputs light from a light source and outputs a flattop intensity pattern in a diverging light stripe. By using a diverging light stripe, the response of the system to a change in position is made to vary approximately proportionally to the inverse of a distance from a reflecting surface to the source of the diverging light stripe. A dual detector approach may be utilized to eliminate the sensitivity of measurement signal with respect to variations in the optical power the light source, as well as other potential variations.

### FIELD OF THE INVENTION

The invention relates generally to precision measurement instruments, and more particularly to a range sensor using structured light intensity for determining displacement measurements.

### BACKGROUND OF THE INVENTION

Various movement or position transducers involve placing a transmitter and a receiver in various geometric configurations to measure movement between two members of the transducer. Certain transducers of this type have used the inverse square attenuation of light reflected from a diffuse surface to calculate the distance from a sensor readhead to the reflecting surface. As an example, U.S. Pat. No. 4,865,443 (the '443 patent) discloses an optical displacement sensor wherein light transmitted from an optical fiber or the like is directed onto a surface whose distance from the sensor is to be measured. The intensity of the reflected light is angle dependent, but within a sufficiently small solid angle the intensity falls off as the inverse square of the distance from the surface. A pair of optical detectors are mounted to receive and detect the reflected light within a small solid angle, wherein their ends are at different distances from the surface. The distance to the surface can then be found in terms of a ratio of the intensity measurements and their known separation length.

U.S. Pat. No. 3,814,994 discloses a system and method for measuring distance which utilizes a pair of light intensity detectors spaced apart in range. As described in the '994 patent, the system employs a method of reflecting electromagnetic energy of a varying intensity from a target to maintain the intensity of the reflected energy at one position at a constant value while monitoring the intensity at a second position to measure the range. More specifically, an arrangement is provided for reflecting light from a target to each of a pair of detectors and maintaining the intensity of the reflected light detected by one detector as a constant value whereby the output signal of the other detector is utilized for calculating a measurement of the range.

U.S. Pat. No. 5,056,913 discloses an optical gauging apparatus utilizing a light projected toward an object and reflected to gauge a distance to the object. As described in the '913 patent, the gauging apparatus includes light projecting elements adapted to project two light beams from first and second light sources or split from the light of a single light source toward the object so that these two light beams provide the object with respective different luminance characteristics. The apparatus also includes a light receiving member that is adapted to receive the light reflected on the object and a signal processor adapted to calculate a ratio of different luminances for the two light beams from the output of the light receiving member and thereby output information on the gauged result.

One of the disadvantages of the prior art systems described above is that the distance from the sensor to the reflecting surface is calculated in accordance with the inverse square attenuation of the light, which contributes to the complexity of the position calculations. Also, the signal decreases rapidly in accordance with the inverse square factor, increasing the sensitivity to errors. The present invention is directed to a sensor that overcomes the foregoing and other disadvantages. More specifically, the present invention is directed to a range sensor that is able to sense the distance from a sensor to a reflecting surface in accordance with an attenuation of light that is inversely proportional to distance, rather than attenuation that is inversely proportional to the distance squared.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A range sensor using structured light intensity for determining displacement measurements is disclosed. As used herein, the term “light’ encompasses both visible and invisible radiation. In accordance with one aspect of the invention, the system includes a light source, a light beam structuring element, a reflective or partially reflective surface and a light sensor. In one embodiment, the light source (e.g. a diode laser, VCSEL, LED, etc.) outputs a beam through the structuring element (e.g. a lens and a line generator) which outputs the beam to the reflective surface (e.g. a mirror). In an embodiment where the structuring element includes a line generator, the line generator may act to shape the beam as a line on the reflective surface. The light sensor receives a portion of the beam from the reflective surface and outputs a corresponding signal. The output of the light sensor varies in accordance with the influence of the distance between the reflective surface and the detector plane on the proportion of the structured light beam that is received by the sensor. By utilizing a structured light beam shaped as a line, the output of the light sensor may vary in a manner inversely proportional to distance, rather than in a manner that is inversely proportional to the distance squared, as is the case for an unmodified point source.

In accordance with another aspect of the invention, the structured light beam diverges according to a first divergence angle in a first plane (e.g. corresponding to the length of the line), and diverges according to a second divergence angle in a second plane that is orthogonal to the first plane (e.g. corresponding to the width of the line). In various embodiments, the first divergence angle may be at least ten times or twenty times the second divergence angle (i.e. the line is at least ten or twenty times longer than it is wide). In other embodiments, the first divergence angle is at least two times the second divergence angle (e.g. the line is at least two times longer than it is wide).

In accordance with another aspect of the invention, the light beam structuring element is configured such that the intensity of the beam as a function of the angle in the first plane (e.g. the intensity of the line along its length) falls within a first range of uniformity. In one embodiment, a line pattern diffuser may be utilized to produce a relatively flat-topped profile over a relatively large divergence angle. In one embodiment, the first range of uniformity may be ±10% compared to the average intensity of the beam over the entire uniform angular range. In another embodiment, the light beam structuring element is configured such that the average intensity of each 2 degree angle increment of the beam is uniform over the uniform angular range within ±5% compared to the average intensity of the output structured light beam over the entire uniform angular range.

In accordance with another aspect of the invention, a second light sensor may also be utilized to receive a portion of the structured light beam that is reflected from the surface. In this embodiment, the distance to the surface is determined based at least in part on the first light sensor signal as compared to the second light sensor signal. In one embodiment, the first light sensor may be at a variable distance from the surface while the second light sensor is at the first variable distance plus an additional constant distance from the surface. It will be appreciated that by utilizing a second light sensor errors may be reduced that otherwise might be caused by fluctuations in the power of the light source.

In accordance with another aspect of the invention, a beamsplitter may be utilized to split a received portion of the structured light beam. In this embodiment, the different portions of the structured light beam that are split travel along different paths to the first and second light sensors. The different paths to the first and second sensors may be of different lengths.

In accordance with another aspect of the invention, a second light source may also be utilized, wherein in one embodiment the second light source may be directed in an opposite direction to the first light source, and a second reflective surface and second detector may be utilized in combination with the second light source. In one embodiment, the distance between the first and second reflective surfaces is fixed (e.g. as attached to a common frame), which moves relative to the fixed positions of the first and second light sensors. By utilizing this balanced detector approach, the signal response is made to vary linearly with the distance to the first surface, and the sensitivity of the signal to the optical power of the source and to temperature fluctuations is reduced. In one embodiment, the second light source may comprise a back facet of the first light source (e.g. both facets of a laser diode are used as outputs).

It will be appreciated that the present invention provides a method and configuration for a simple, inexpensive position sensor with a linear signal response to position. In one embodiment, the scale-less sensor makes use of engineered micro-lens array technologies or engineering diffractive optical element (DOE) technologies to create the flat-top line profile, either of which may be made using volume manufacturing options to produce parts at low cost.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A and 1B are diagrams of top and side views of a range sensor utilizing a structured light beam which is reflected to be received by a single detector for determining displacement measurements;

FIG. 2 is a diagram of a top view of a range sensor wherein a portion of a structured light beam is split by a beamsplitter and is received by two detectors for determining displacement measurements;

FIG. 3 is an isometric diagram of a range sensor wherein a portion of a structured light beam is reflected by a multi-pass mirror arrangement and is split by a beamsplitter to be received by two detectors for determining displacement measurements; and

FIG. 4 is a diagram of a top view of a range sensor in which both facets of a light source are utilized as outputs for two structured light beams which are received by two detectors for determining displacement measurements.

### DETAILED DESCRIPTION OF THE PREFERRED EMBODIMENT

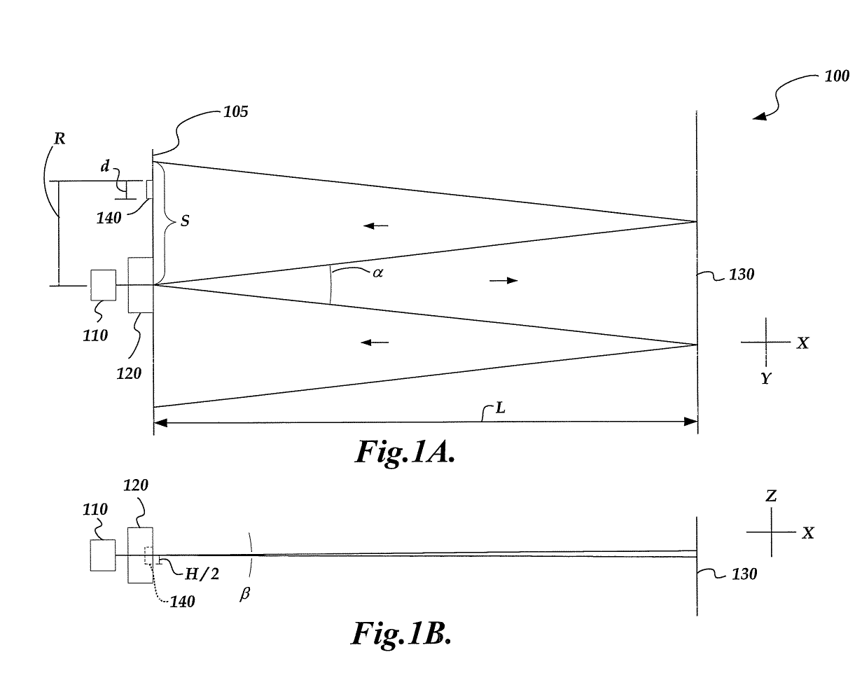

FIGS. 1A and 1B are diagrams of top and side views, respectively, of one exemplary embodiment of a range sensor 100 using structured light intensity for determining displacement measurements in accordance with the present invention. As shown in FIG. 1A, a source 110, beam structuring element 120 and detector 140 are shown proximate to a detector plane 105. In one embodiment, the source 110, beam structuring element 120 and detector 140 are fixed to a body (not shown) of the sensor 100. The source 110 may in certain embodiments be a light source such as a laser, VCSEL, LED, etc. In one embodiment, the beam structuring element 120 may comprise a lens and a line generator, in which case the light from the source 110 is collimated by the lens and is directed through the line generator. In one embodiment, the beam from the beam structuring element 120 is reflected by a mirror 130. After the beam is reflected by the mirror 130, a portion of the reflected light is received by the detector 140. As will be described in more detail below, the amount of optical power that is received by the detector 140 is related to the distance between the detector plane 105 and the mirror 130.

In operation, as the mirror 130 (e.g. as attached to a movable probe tip) moves closer to the detector plane 105, a greater percentage of the optical power from the beam is received by the detector 140, which causes a corresponding increase in the output voltage or current from the detector 140. Conceptually, in an embodiment where the beam structuring element 120 utilizes a line generator to shape the beam, as the mirror 130 moves closer to the detector plane 105, the line length at the detector plane is less, and thus a larger proportion of the beam (and/or beam energy) is received in the aperture of the detector 140. Thus, the output of the detector 140 is related to the distance between the detector plane 105 and the mirror 130, and can be used to determine a displacement measurement. In one application, the source 110, beam structuring element 120 and detector 140 may be fixed in the body of a measuring gauge (not shown) that includes a linearly moving spindle that provides an external measurement probe tip. The mirror 130 is mounted to move along with the linearly moving spindle, such that the measurement gauge can be used to determine the position or displacement of the moving spindle and/or the probe tip relative to the body of the gauge.

As shown in FIG. 1A, an angle α represents the “line length-determining” total divergence angle of the light beam shown in the top view, which is relatively large when compared with the “line width-determining” divergence angle β of the light beam shown in the side view of FIG. 1B. This is consistent with an embodiment where the beam structuring element 120 utilizes a line generator to shape the beam such that the length of the line at the mirror 130 is determined by the angle α, while the width of the line is determined by the angle β.

In one embodiment, the line generator used in the beam structuring element 120 may be a line pattern diffuser. Line pattern diffusers are capable of producing relatively uniform “flat-topped” intensity profiles over selected divergence angles. In one specific example embodiment, a line pattern diffuser is able to provide a line width divergence of approximately 0.4°, while producing a relatively uniform flat-topped intensity profile over relatively large divergence angles (e.g., total divergence angles of up to 100°). One example of such a line generator is an Engineered Diffuser™, manufactured by RPC Photonics Inc., Rochester, N.Y. The line profile of such a diffuser may be designed to have a uniform profile over a very wide line length divergence angle. In one such diffuser, the central ±15° of the profile is relatively flat and provides the range used in one embodiment the scale-less sensor. The intensity profile along the orthogonal direction of this device is Gaussian and has a divergence angle of approximately ±0.2°. Irregularities in the profile that have a high spatial frequency may also be smoothed out by a number of methods including using an LED source and/or optimizing the near-collimation of the beam entering the diffuser (e.g. by having the beam slightly diverging, slightly converging, minimally diffuse, etc.)

In one embodiment, the measuring range of the detector is dictated by the geometry of the sensing head (comprising the source 110, the beam structuring element 120 and the detector 140). The following description assumes that the detector 140 is coplanar with the effective origin (e.g. approximately at the output surface of the beam structuring element 120) of the diverging light stripe. The dimension from the effective origin of the diverging light stripe to the outer edge of the detector 140 is denoted R, and the dimension to the outer edge of the diverging light stripe in the detector plane is denoted S, as shown. A distance L represents the separation between the detector plane 105 and the mirror 130. For this configuration, the desirable minimum range corresponds to S≧R. For S<R the diverging light stripe will not extend across the entire detector, which leads to a poorly-behaved output as a function of L, and is not a desirable regime of operation, in general. Therefore, a minimum limit of the measurement range may be approximately Lmin=[R/(2*tan(α/2))].

The dimension from the effective origin of the diverging light stripe to the lower (and/or upper) edge of the detector 140 is denoted H/2. A maximum limit of the measurement range may correspond to approximately Lmax=[H/(4*tan(β/2))]. For L>Lmax the width of the diverging light stripe along the z-axis direction will begin to exceed the limits of detector 140, which leads to a poorly-behaved output as a function of L, and is not a desirable regime of operation, in general.

In one specific example embodiment, the beam profile corresponds to total divergence angles of α×β=15.0°×0.4°. For an aperture dimension H=4.0 mm, centered along the z-axis direction of the detector 140, Lmax=[H/(4*tan(β/2))]=286 mm. For a dimension R=5.0 mm along the y-axis direction of the detector 140, Lmin=[R/(2*tan(α/2))]=19 mm.

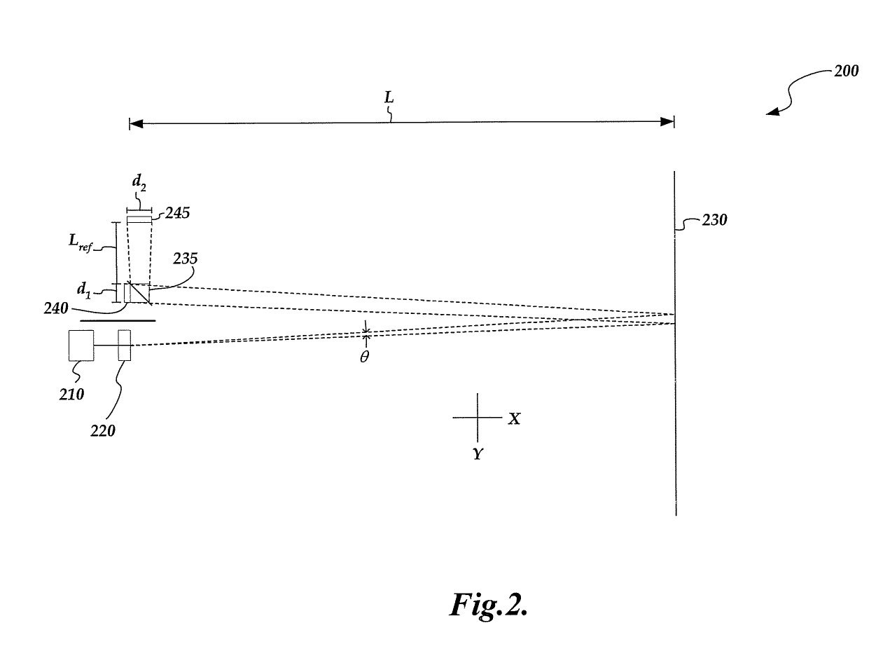

FIG. 2 is a diagram of a top view of an exemplary embodiment of a range sensor 200. The components of the range sensor 200 will be understood to be similar to the components of the range sensor 100 of FIG. 1, except as otherwise described below. As shown in FIG. 2, a source 210 outputs a beam which passes through a beam structuring element 220. In one embodiment, the beam structuring element 220 may comprise a lens and a line generator, e.g. to project a line-shaped “light stripe” in a manner similar to that previously described with reference to FIG. 1. The light stripe from the beam structuring element 220 is reflected by a mirror 230 and a portion of the light stripe approximately corresponding to the angle θ reaches a beamsplitter 235. The energy of the portion of the light stripe that reaches the beamsplitter 235 is split into two sub-portions that are received by two detectors 240 and 245, respectively. The outputs of the two detectors 240 and 245 are related to the distance L between the mirror 230 and the effective origin of the diverging light stripe (e.g. at the beam structuring element 220). The distance L can be calculated in accordance with the following equations:

The output from the first detector 240 may be represented as:

$${O}_{1} = \frac{P * {k}_{d 1} * {k}_{s}}{2 L} \qquad ( Eq . 1 )$$

where P is the light source power, kd1 is a transducer constant (which may be determined by design and/or calibration, and generally depends on the line length divergence angle, detector 240 size, conversion efficiency, etc.), ks is the transmission coefficient of the beamsplitter 235, and L is the distance from the effective origin (e.g. at the beam structuring element 220) of the diverging light stripe to the mirror 230. The equation assumes that the detector 240 is coplanar with the effective origin (e.g. at the beam structuring element 220) of the diverging light stripe.

The output from the second detector 245 is represented as:

$${O}_{2} = \frac{P * {k}_{d 2} * ( 1 - {k}_{s} )}{2 L + {L}_{ref}} \qquad ( Eq . 2 )$$

where P is the light source power, kd2 is a transducer constant (which may be determined by design and/or calibration, and generally depends on the line length divergence angle, detector 245 size, conversion efficiency, etc.), ks is the transmission coefficient of the beamsplitter 235 (assuming no energy is lost at the beamsplitter 235), L is the distance from the effective origin (e.g. at the beam structuring element 220) of the diverging light stripe to the reflective surface, and Lref is the extra distance from the beamsplitter 235 to the detector 245.

The ratio of the signals is:

$$\begin{matrix}\frac{{O}_{1}}{{O}_{2}} = \frac{P * {k}_{d 1} * {k}_{s}}{P * {k}_{d 2} * ( 1 - {k}_{s} )} * \frac{2 L + {L}_{ref}}{2 L} = \frac{P * {k}_{d 1} * {k}_{s}}{P * {k}_{d 2} * ( 1 - {k}_{s} )} * ( 1 + \frac{{L}_{ref}}{2 L} ) \\ and letting \text{:} & ( Eq . 3 ) \\ C = \frac{{k}_{d 1} * {k}_{s}}{{k}_{d 2} * ( 1 - {k}_{s} )} & ( Eq . 4 )\end{matrix}$$

and rearranging the previous equation:

$$2 L = C * \frac{{O}_{2}}{{O}_{1}} ( 2 L + {L}_{ref} ) = 2 L * C * \frac{{O}_{2}}{{O}_{1}} + {L}_{ref} * C * \frac{{O}_{2}}{{O}_{1}} \qquad ( Eq . 5 )$$

and further rearranging:

$$2 L ( 1 - C * \frac{{O}_{2}}{{O}_{1}} ) = {L}_{ref} * C * \frac{{O}_{2}}{{O}_{1}} \qquad ( Eq . 6 )$$

and solving for the distance L:

$$L = \frac{{L}_{ref}}{2} * \frac{C}{( \frac{{O}_{1}}{{O}_{2}} - C )} \qquad ( Eq . 7 )$$

and if the two detectors 240 and 245 are identical and the beamsplitter 235 transmission coefficient is 0.5, then:

$$L = \frac{{L}_{ref}}{2} * \frac{1}{( \frac{{O}_{1}}{{O}_{2}} - 1 )} \qquad ( Eq . 8 )$$

The embodiment described with reference to FIG. 2 is advantageous in comparison to the embodiment shown in FIG. 1, in that the measurement of L is insensitive to variations in power of the source 210. Furthermore, since the detectors 240 and 245 both input energy from the same portion of the light stripe, approximately corresponding to the angle θ, the measurement of L is also nominally insensitive to minor variations in the uniformity of the intensity along the length of the light stripe, and variations in the reflectivity and/or contamination of the mirror 230, etc.

It should be appreciated that EQUATION 1 can be applied to the embodiment shown in FIG. 1, by setting ks=1 (or deleting ks entirely). In that case, L can be determined from the output of a single detector by rearranging EQUATION 1. In such an embodiment, to obtain good accuracy, the light source power should be controlled to be consistent (stable) and the intensity along the length of the light stripe should be as uniform as possible. An alternative to precisely stabilizing the light source power is to monitor the light source power using power monitoring circuit (not shown) to determine the value for P in EQUATION 1, whenever a value for O1 is determined. In one embodiment, the power monitoring circuit may include a photodetector that is fixed relative to a laser diode that is used for the light source 110, to receive the optical power emitted from its back facet, in order to provide a signal proportional to P. To obtain the best accuracy using the embodiment shown in FIG. 1, kd1 may be calibrated as a function of L (e.g. the calibrated values of kd1 may be stored in a look up table as a function of L), in order to compensate for slight variations in the uniformity of the intensity along the length of the light stripe. In the latter case, in operation, L may initially be estimated from an average value of kd1, and then the estimate of L may be iteratively improved by using the initial estimate of L to identify a corresponding calibrated value of kd1, re-estimating the value of L based on the calibrated value of kd1, and so on, until a final measurement value of L is sufficiently accurate (e.g. converges to a final value according to the preceding procedure).

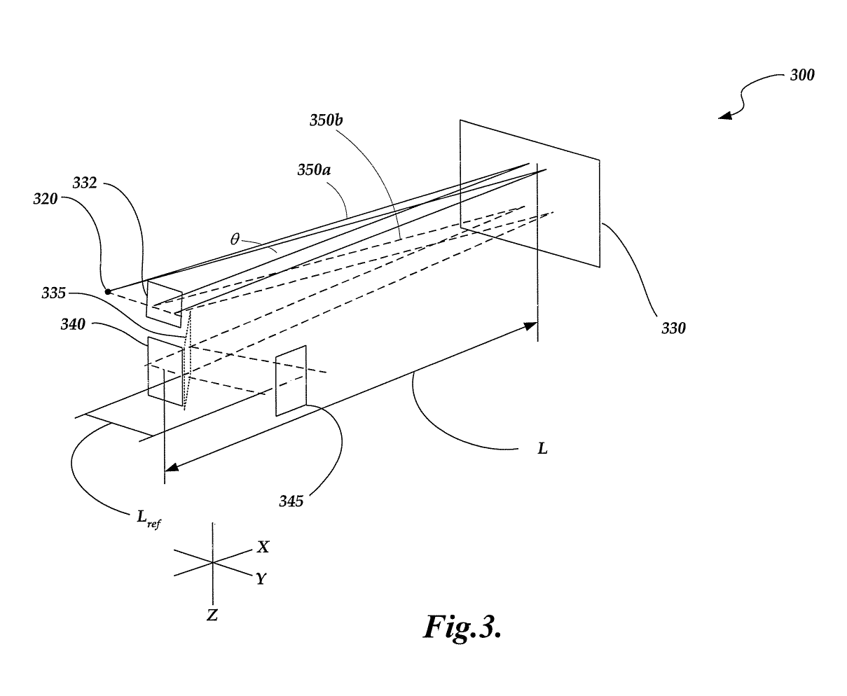

FIG. 3 is an isometric diagram of an exemplary embodiment of a range sensor 300. The components of the range sensor 300 will be understood to be similar to those of the range sensors 100 and 200 of FIGS. 1 and 2 except as otherwise described below. As shown in FIG. 3, a beam from a beam structuring element 320 (not shown) forms a light stripe 350a that is reflected by a mirror 330, and is then further reflected by a multi-pass mirror 332. In one embodiment, the multi-pass mirror 332 is rotated slightly about the y-axis, such that it reflects a light stripe 350b that is deflected somewhat along the z-axis direction. After being reflected by the multi-pass mirror 332, the light stripe 350b is again reflected by the mirror 330 and a portion of the light stripe 350b approximately corresponding to the angle θ reaches a beamsplitter 335. The energy in the portion of the beam that reaches the beamsplitter 335 is split into two sub-portions that are directed toward the two detectors 340 and 345, respectively.

The outputs of the two detectors 340 and 345 are analogous to the outputs O1 and O2 from the detectors 240 and 245, described with reference to FIG. 2. In one embodiment, the effective origin of the diverging light stripe (e.g. at the beam structuring element 320) and the multi-pass mirror 332 are both located at the detector plane of the detector 340. In such a case, EQUATIONS 1-8 may be applied to determine L for the embodiment shown in FIG. 3, with the exception that each instance of L should be replaced by 2L in the equations. It should be appreciated that as L is varied, the position of the light stripe on the detectors will vary along the z-axis direction, which is a consideration that may further decrease Lmax, in comparison to the considerations outlined with reference to FIG. 1. As previously outlined, if the diverging light stripe 350b exceeds the limits of the detector 340, then the output as a function of L will be poorly behaved. For this reason, the deflection angle of the light stripe 350b should be minimal, so that the variation of the light stripe position with variations in L will be acceptable. Furthermore, the dimensions of the detectors 340 and 345 should be large enough along the z-axis direction to provide the desired maximum measuring range, in light of both the beam divergence angle β and the additional deflection angle associated with the multi-pass mirror 332.

The embodiment described with reference to FIG. 3 has the advantages previously outlined with reference to FIG. 2. In addition, it is advantageous for some applications in that the output variation or scale factor with respect to variations in L is twice that of the configuration shown in FIG. 2, when other design factors are the same (e.g. divergence angles, detector sensitivity, etc.).

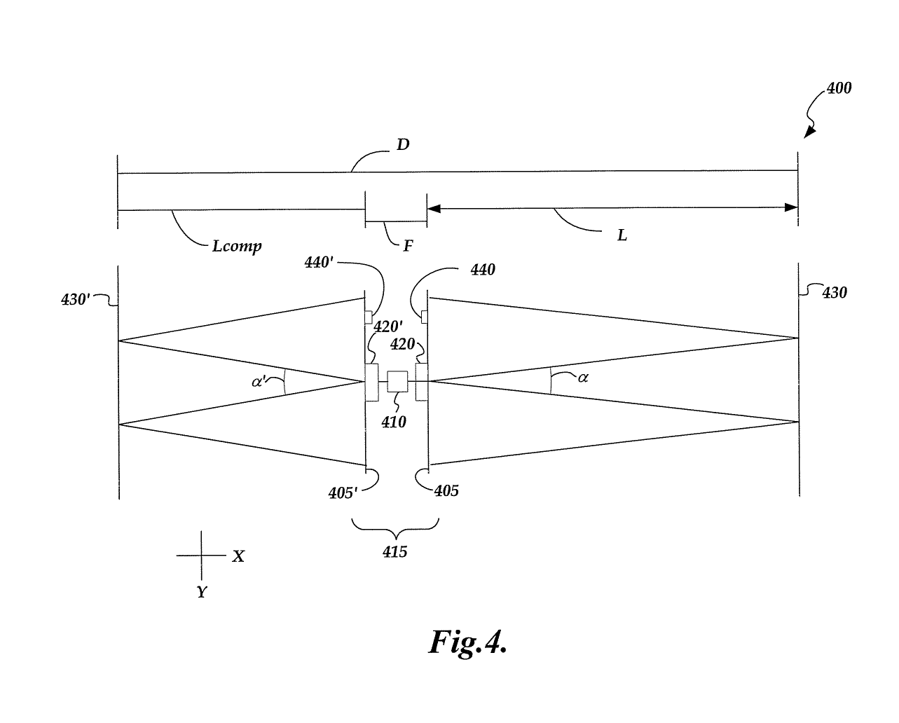

FIG. 4 is a diagram of a top view of one exemplary embodiment of a range sensor 400 using balanced detectors 440 and 440′. As shown in FIG. 4, a single source 410 is utilized to propagate two light beams in opposite directions. In one embodiment, the source 410 may be a laser diode with both facets used as outputs. In other embodiments, a single source, single collimating lens, single line generator and combinations of beam splitters and mirrors may alternatively be utilized to generate the two light beams. In one embodiment, the light source(s) and detectors are mounted on an isothermal block so that they are relatively immune to temperature fluctuations.

As shown in FIG. 4, the two beams from the source 410 propagate in opposite directions through respective beam structuring elements 420 and 420′. In an embodiment where the beam structuring elements 420 and 420′ comprise lenses and line generators, the beams may be separately collimated by the lenses and pass through the line generators to produce diverging light stripes with respective divergence angles α and α′. The diverging light stripes are then reflected by two respective reflective targets 430 and 430′. The relative light intensities at the two respective detectors 440 and 440′ are then used to determine position.

The outputs of the two detectors 440 and 440′ are related to the two distances L and Lcomp, respectively, which denote the distances between the detector planes 405 and 405′ and the mirrors 430 and 430′, respectively, according to previously outlined principles. A distance F represents the distance between the detector planes 405 and 405′, while a distance D represents the distance between the mirrors 430 and 430′. In one embodiment, the distances D and F are fixed, but the sensing head 415 (comprising the source 410, the beam structuring elements 420 and 420′, and the detectors 440 and 440′) moves relative to the mirrors 430 such that the distances L and Lcomp are variable. The distance L=(D-F)-Lcomp. The distances L and Lcomp can be calculated in accordance with the following equations:

The output from the first detector 440 may be represented as:

$${O}_{1} = \frac{P * {k}_{d 1} * {k}_{s 1}}{2 L} \qquad ( Eq . 9 )$$

where P is the light source power, kd1 is a transducer constant (which may be determined by design and/or calibration, and generally depends on the detector 440 size, conversion efficiency, etc.), ks1 is the overall constant that reflects the divergence geometry, surface reflectance, etc. that determines the intensity at the detector 440 for the first light beam, L is the distance from the effective origin (e.g. at the detector plane 405) of the first diverging light stripe to the reflective surface 430. The equation assumes that the detector 440 is coplanar with the effective origin of the diverging light stripe (e.g. at the detector plane 405).

The output from the second detector 440 is represented as:

$${O}_{2} = \frac{P * {k}_{d 2} * {k}_{s 2}}{2 {L}_{comp}} \qquad ( Eq . 10 )$$

where P is the light source power, kd2 is a transducer constant (which may be determined by design and/or calibration, and generally depends on the detector 440′ size, conversion efficiency, etc.), ks2 is the overall constant that reflects the divergence geometry, second surface 430′ reflectance, etc. that determines the intensity at the second detector 440′ for the second light beam, Lcomp is the distance from the effective origin (e.g. at the detector plane 405′) of the second diverging light stripe to the second reflective surface 430′. The equation assumes that the detector 440′ is coplanar with the effective origin of the second diverging light stripe (e.g. at the detector plane 405).

The ratio of the signals is:

$$\frac{{O}_{1}}{{O}_{2}} = \frac{P * {k}_{d 1} * {k}_{s 1}}{P * {k}_{d 2} * {k}_{s 2}} * \frac{2 {L}_{comp}}{2 L} \qquad ( Eq . 11 )$$

and substituting:

L_{comp}=(D−F)−L (Eq. 12)

where D and F are fixed by design, and L is a variable distance:

$$\begin{matrix}\frac{{O}_{1}}{{O}_{2}} = \frac{P * {k}_{d 1} * {k}_{s 1}}{P * {k}_{d 2} * {k}_{s 2}} * \frac{2 [ ( D - F ) - L ]}{2 L} \\ and letting \text{:} & ( Eq . 13 ) \\ {C}^{′} = \frac{{k}_{d 1} * {k}_{s 1}}{{k}_{d 2} * {k}_{s 2}} & ( Eq . 14 )\end{matrix}$$

and rearranging the previous equation:

$$2 L = {C}^{′} * \frac{{O}_{2}}{{O}_{1}} 2 [ ( D - F ) - L ] = 2 ( D - F ) * {C}^{′} * \frac{{O}_{2}}{{O}_{1}} 2 L * {C}^{′} * \frac{{O}_{2}}{{O}_{1}} \qquad ( Eq . 15 )$$

and further rearranging:

$$\begin{matrix}2 L ( 1 + {C}^{′} * \frac{{O}_{2}}{{O}_{1}} ) = 2 ( D - F ) * {C}^{′} * \frac{{O}_{2}}{{O}_{1}} \\ and finally \text{:} & ( Eq . 16 ) \\ L = ( D - F ) * \frac{{C}^{′}}{( \frac{{O}_{1}}{{O}_{2}} + {C}^{′} )} & ( Eq . 17 )\end{matrix}$$

It will be appreciated that the invention outlined herein provides for linearization of an output signal with respect to the position of a scale-less position transducer, as well as other advantages. As described above, in one embodiment a micro-lens array or a diffractive optical element may be used to generate a “flattop” intensity profile along a diverging light stripe including light originating from a diode laser, VCSEL, or LED light source. By generating a diverging light stripe in this manner, the output of the system in response to a change in position is made to vary approximately proportionally to the inverse of a distance from a reflecting surface to the source of the diverging light stripe. Stated another way, the first derivative of the voltage signal may be approximately constant with respect to position through the linearization of the transfer function. The components are also relatively inexpensive to manufacture in that most of the costs of the line generator are incurred in the design, prototyping, and mastering, such that once a master of the line generator and system is produced, volume manufacturing options such as replication, injection molding, compression molding, web roll-to-roll processes, etc. may be utilized to produce parts at a low cost. Furthermore, either a beam splitting approach or a dual beam approach using two detectors reduces sensitivity to offsets and drifts arising from temperature changes and light source power fluctuations. The beam splitting approach may also reduce the sensitivity to certain non-uniformities in the diverging light stripe output from a beam structuring element and/or variations in the properties of the reflective surface. It will be appreciated that this technique improves the robustness and stability of the signal. It will be appreciated that although the reflective surfaces 130, 230 and the like have been described herein as mirrors, light scattering Lambertian or partially diffuse surfaces may alternatively be used in certain embodiments or applications, and at least some of the advantages of the invention will be retained. The previously discussed '443 patent describes several considerations related to the general properties of the reflected intensity from such light scattering surfaces.

While the preferred embodiment of the invention has been illustrated and described, numerous variations in the illustrated and described arrangements of features and sequences of operations will be apparent to one skilled in the art based on this disclosure. Thus, it will be appreciated that various changes can be made therein without departing from the spirit and scope of the invention.

The embodiments of the invention in which an exclusive property or privilege is: claimed are defined as follows:

1. A sensor for determining a distance to a surface, the sensor comprising:
a first light source;
a first light beam structuring element arranged to receive light from the first light source and output a structured light beam toward the surface; and
a first light sensor arranged to receive a first portion of the structured light beam that is reflected from the surface and to output a first light sensor signal that corresponds to an optical power of the first received portion of the reflected structured light beam,
wherein:
the first light beam structuring element is configured such that the output structured light beam diverges according to a first divergence angle in a first plane and diverges according to a second divergence angle in a second plane that is orthogonal to the first plane;
the first divergence angle is at least two times the second divergence angle; and
the distance is determined based at least partially on the first light sensor signal.

2. The sensor of claim 1, wherein the first divergence angle is at least ten times the second divergence angle.

3. The sensor of claim 2, wherein the first divergence angle is at least twenty times the second divergence angle.

4. The sensor of claim 1, wherein:
the first light beam structuring element is configured such that the intensity of the output structured light beam as a function of angle in the first plane falls within a first range of uniformity, at least over a uniform angular range corresponding to light received by the first light sensor over a defined range of distance measurements.

5. The sensor of claim 4, wherein:
the first range of uniformity is ±10% compared to the average intensity of the output structured light beam over the entire uniform angular range.

6. The sensor of claim 4, wherein the first light beam structuring element is configured such that the average intensity of each 2° angle increment of the output structured light beam is uniform over the uniform angular range, within 35 5% compared to the average intensity of the output structured light beam over the entire uniform angular range.

7. The sensor of claim 4, wherein the first light beam structuring element comprises a diffuser that outputs a partially diffuse structured light beam.

8. The sensor of claim 1, further comprising a second light sensor arranged to receive a second portion of the structured light beam that is reflected from the surface and to output a second light sensor signal that corresponds to an optical power of the second received portion of the reflected structured light beam,
wherein:
the distance is determined based at least partially on the first light sensor signal and the second light sensor signal.

9. The sensor of claim 8, wherein the first and second light sensors are at different distances from the surface.

10. The sensor of claim 9, wherein the first light sensor is at a first variable distance from the surface and the second light sensor is at the first variable distance plus an additional constant distance from the surface.

11. The sensor of claim 1, further comprising:
a second light sensor arranged to receive a second portion of the structured light beam that is reflected from the surface and to output a second light sensor signal that corresponds to an optical power of the second received portion of the reflected structured light beam;
a beamsplitter arranged to input an input portion of the structured light beam that is reflected from the surface and to output the first portion of the structured light beam along a first detector path to be received by the first light sensor, and to output the second portion of the structured light beam along a second detector path to be received by the second light sensor,
wherein:
the distance is determined based at least partially on the first light sensor signal and the second light sensor signal.

12. The sensor of claim 11, wherein the first detector path and the second detector path have different lengths.

13. The sensor of claim 1, further comprising:
a second light sensor arranged to receive power-indicating light from the first light source and to output a second light sensor signal that corresponds to an optical power of the power-indicating light;
wherein:
the distance is determined based at least partially on the first light sensor signal and the second light sensor signal.

14. The sensor of claim 13, wherein the power-indicating light is output by a back facet of the first light source.

15. The sensor of claim 1, further comprising:
a second light source;
a second light beam structuring element arranged to receive light from the second light source and output a second structured light beam toward a second surface; and
a second light sensor arranged to receive a portion of the second structured light beam that is reflected from the second surface and to output a second light sensor signal that corresponds to an optical power of the received portion of the reflected second structured light beam,
wherein:
the second light beam structuring element is configured such that the second output structured light beam diverges according to a third divergence angle in the first plane and diverges according to a fourth divergence angle in the second plane that is orthogonal to the first plane;
the third divergence angle is at least two times the fourth divergence angle; and
the distance is determined based at least partially on the first light sensor signal and the second light sensor signal.

16. The sensor of claim 15, wherein the second light source comprises a back facet of the first light source.

17. A method for determining a distance to a surface, the method comprising:
outputting a structured light beam toward the surface;
receiving a first portion of the structured light beam that is reflected from the surface and outputting a first light sensor signal that corresponds to an optical power of the first received portion of the reflected structured light beam,
wherein:
the output structured light beam diverges according to a first divergence angle in a first plane and diverges according to a second divergence angle in a second plane that is orthogonal to the first plane;
the first divergence angle is at least two times the second divergence angle; and
the distance is determined based at least partially on the first light sensor signal.

18. The method of claim 17, wherein the first divergence angle is at least ten times the second divergence angle.

19. The method of claim 17, wherein the first divergence angle is at least twenty times the second divergence angle.

20. The method of claim 17, further comprising receiving a second portion of the structured light beam that is reflected from the surface and outputing a second light sensor signal that corresponds to an optical power of the second received portion of the reflected structured light beam, wherein the distance is determined based at least partially on the first light sensor signal and the second light sensor signal.
